(19) United States
(12) Patent Application Publication
(10) Pub. No.: US 2015/0172920 A1
(43) Pub. Date: Jun. 18, 2015

(54) SYSTEM FOR PROXIMITY BASED ENCRYPTION AND DECRYPTION

(71) Applicant: Mourad Ben Ayed, Cupertino, CA (US)

(72) Inventor: Mourad Ben Ayed, Cupertino, CA (US)

(21) Appl. No.: 14/107,014

(22) Filed: Dec. 16, 2013

(51) Int. Cl. H04W 12/06; H04L 9/32; H04L 29/06

(52) U.S. Cl. CPC H04W 12/06; H04L 63/0853; H04L 9/3234

(57) ABSTRACT

A method for securing data on a mobile device by combining multi-factor, auto-login, encryption and proximity. The method uses a wireless device to store encryption keys, provides a first stage decryption to decrypt the user credentials and login to a container, and a second stage decryption to decrypt the user data and display it. The method also locks the data when the user leaves proximity. This method is immune to physical attacks or jailbreaks.

### PRIORITY

The present application is a Continuation-In-Part (“CIP”) of pending U.S. patent application Ser. No. 13/689,760, filed Nov. 29, 2012.

### FIELD OF THE INVENTION

The present invention relates to mobile security and more specifically relates to encryption using a key stored on a remote short wireless device.

### BACKGROUND

User authentication in computing systems traditionally depends on three factors: something you have (e.g., hardware token), something you are (e.g., a fingerprint), and something you know (e.g., a password). In this patent, we explore a new type of short wireless mobile device that performs all these factors and that is compatible with mobile devices.

U.S. Pat. No. 8,045,961 by the current inventor describes a System for Wireless Authentication Based on BLUETOOTH Proximity.

Although this application teaches automatic login, it does not describes real-time data encryption and decryption using a remote key.
U.S. Pat. No. 7,973,657 by the current inventor titled System For Monitoring Proximity To Prevent Loss Or To Assist Recovery teaches a BLUETOOTH keychain with a proximity alarm, a headset function and that sends data for login.
The current patent does not teach real-time data encryption and decryption using a key that is stored on a remote device.
U.S. Pat. No. 7,664,463 by the current inventor titled Portable Loss Prevention System describes a BLUETOOTH loss prevention system. The described system does not provide real-time encryption and decryption of data using a key that is stored on a remote device.

U.S. Pat. No. 8,115,609 by Ketari et al. describes a Proximity Access and Alarm Apparatus that uses a proximity device. Ketari does not describe real-time encryption and decryption of data using a key stored on a remote device. Similarly, patent number 8112037 by Ketari describes BLUETOOTH access and proximity alarm devices with no real-time encryption and decryption of data using a key that is stored on a remote device.

U.S. Pat. No. 7,463,861 by Eisenbach et al. titled Automatic data encryption and access control based on BLUETOOTH device proximity teaches a method and apparatus for securing sensitive data on a secured BLUETOOTH device whereby when contact is lost, sensitive data is automatically encrypted, and when contact is restored, the data is automatically decrypted. Eisenbach's invention does use a key that is stored on a remote device, does not do automatic login, and does not keep on sending device location when the device is lost.

Thus, a need exists for systems for providing convenient real-time encryption/decryption, automatic login, and automatic locking and alerting.

### SUMMARY OF THE INVENTION

A method for proximity encryption and decryption comprising:

upon or after an event onboard the user terminal, the authorization program connects to the at least one token device using short wireless communication, wherein the at least one token device is more than 10 centimeters away from the user terminal,
after or upon a pass code or a voice response is validated without a server either onboard the user terminal or onboard the at least one token device,
at least one decryption key is obtained wirelessly from the at least one token device,
a login information stored onboard the user terminal can be decrypted using the at least one decryption key,
the login information can be used to login automatically to the at least one second user account from the user terminal,
at least one data set corresponding to the second user account is obtained wirelessly from the at least one application service,
the at least one data set is decrypted using at least a second digital key obtained through short wireless communication to obtain at least one decrypted data set onboard the user terminal,
at least one information from the at least one decrypted data set is output onboard the user terminal,
at least one input data set obtained onboard the user terminal can be encrypted using at least a third digital key obtained through short wireless communication,
and at least one part of the encrypted at least one input data set can be sent wirelessly to the at least one application service.

A method for proximity encryption and decryption comprising:

at least one data set corresponding to the application program is encrypted with an encryption key obtained from at least one token device to obtain at least one encrypted data set,
wherein the application program can read the at least one data set,
wherein when encrypted, the application program cannot read the at least one encrypted data set;
whereby upon or after an event onboard the user terminal,
the authorization program connects to at least one token device using short wireless communication,
at least one decryption key is obtained wirelessly,
at least one encrypted data set is obtained and is decrypted using the at least one decryption key,
the application program reads the decrypted data set,
and at least one information from the decrypted data set is displayed onboard the user terminal using the application program;
whereby if the at least one token device is not within a predefined short wireless range from the user terminal,
a displayed data is cloaked or a screen is locked,
at least one data set corresponding to the application program can be encrypted with an encryption key obtained wirelessly to obtain an encrypted data set,
and wherein the predefined short wireless range is above 30 centimeters.

A method for proximity encryption and decryption comprising:

upon or after an event onboard the user terminal,
the authorization program scans devices within a predefined range from the user terminal using short wireless communication,
if a known token device is found,
login information corresponding to the token device can be obtained and can be used to authorize to the at least one second user account,
and at least one information from the at least one second user account is displayed onboard the user terminal;
whereby upon or after activation of a button or an icon or a menu from the displayed information onboard the user terminal,
at least one request is sent to the at least one token device or to the policy server,
whereby upon or after authorization of the at least one request by the at least one token device,
authorization information is obtained,
and the authorization information is used to login automatically to the at least one third user account or to authenticate to the at least one third user account or to authorize a transaction corresponding to the at least one third user account onboard the user terminal;
whereby if the at least one token device leaves a predefined short wireless range from the user terminal,
the data from the at least one second user account is automatically cloaked or encrypted, or the at least one second user account is logged off or locked.

### BRIEF DESCRIPTION OF THE FIGURES

The present inventions may be more clearly understood by referring to the following figures and further details of the inventions that follow.

FIG. 1 is a schematic of a system for encryption and decryption using a smart phone

FIG. 2 is a schematic of a system for encryption and decryption using a fob

FIG. 3 is a flowchart illustrating encryption and decryption of data

FIG. 4 is a flowchart illustrating encryption and decryption of data for web services

FIG. 5 is a flowchart illustrating an alternative method for encryption and decryption of data for web services

FIG. 6 is a flowchart illustrating proximity security

Similar reference numerals are used in different figures to denote similar components.

### FURTHER DETAILS OF THE INVENTIONS

The current invention addresses the problem of how to secure application data with an encryption key stored on a second factor.

Current software-as-a-service (SAAS) applications, email applications and mobile applications such as Good Email . . . use FIPS140-2 validated encryption to encrypt data with a key that is stored on the user terminal in a secured storage location such as iOS keychain or secure element. Those applications encrypt resident data (when data is stored on the device), and encrypt the data in transit (when data travels between the user terminal and the application service), however, they do not have multi-factor and do not have end-to-end encryption and often store the data un-encrypted in a database.

These systems are vulnerable to physical attacks on the user terminal, to server attacks, man-in-the-middle attacks, jailbreak and to internal attacks. Attacks on the user terminal:

The secured storage locations on the user terminal open with a simple pass code, and once opened, they remain open. A device left un-attended after login, a password attack or device snatching exposes the keychain and all the applications.
Server attacks:
There are several known attacks such as SQL injection

### Man-in-the-middle:

There are several known man-in-the-middle attacks

### Jailbreak:

Jailbreak attacks target the keychain. Once opened, all the encryption keys are exposed.
Internal attacks:
Internal attacks such as Wiki leaks or Snowden are increasing in intensity and gravity. The current invention protects against physical attacks, server attacks, man-in-the-middle attacks, jailbreak and internal attacks by encrypting data using an encryption key that is never stored on the user device. Data is encrypted end-to-end, and is decrypted on the destination device using a decryption key that is not store on the destination device. Moreover, if the user of the user terminal is not within proximity of the user terminal, data is locked and is never decrypted.
The current invention is useful, functional and novel in that it is always multi-factor, the user does not have to type complex passwords when near the user terminal, and the user does not need to lock the device when leaving proximity of the data. The data cannot be accessed unless the user has a second factor. Moreover, this method gives a simple upgrade path for legacy applications. Breakthrough user experience and breakthrough security.

While the state of the art today is trust the device (Mobile Device Management or MDM) or trust the application (Mobile Application Management or MAM), the current invention says: “Only trust the user”.

The current invention utilizes features of short wireless transceivers (such as BLUETOOTH, ANT, WIBREE, NFC, ZIGBEE, etc.) to provide short wireless proximity monitoring. This new technology also provides several alerts and data protection function when the user mobile terminal is away from the device of the invention, thus preventing loss and theft of mobile terminals, and protecting data in case the device cannot be recovered.

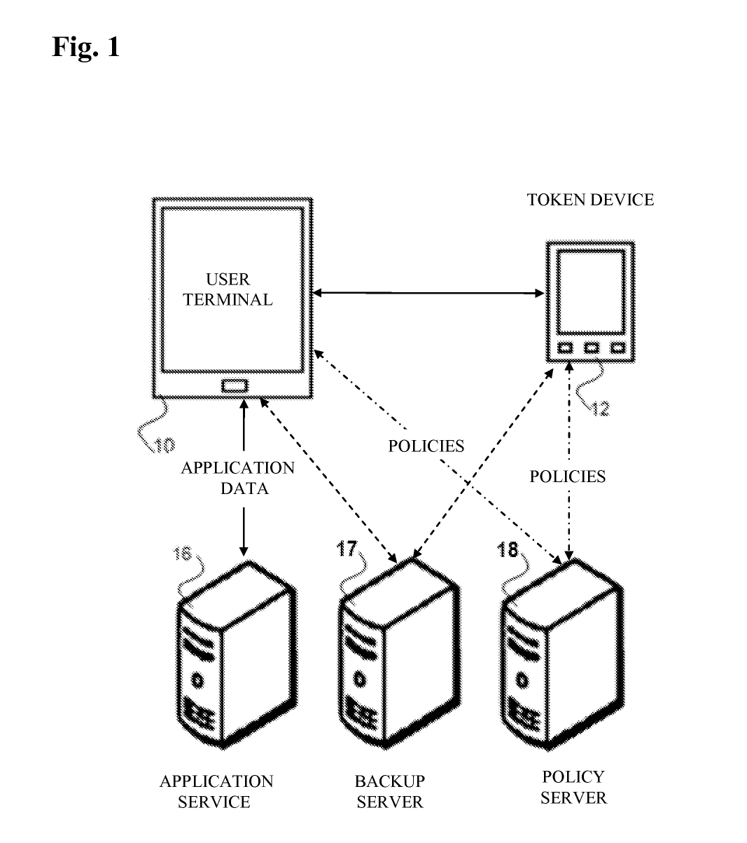

Referring to FIG. 1, the schematic illustrates a system for encryption and decryption using a smart phone. The system for mobile security comprises a user terminal 10, a token device 12, an application service 16, a policy server 18 and possibly a backup server 17.

The token device 12 is a Bluetooth fob or a smart phone equipped with short wireless communication means. The token device has a token application running.
The token device is distinct from the user terminal 10 and stores at least one digital key in memory. The digital key is used to encrypt or decrypt data onboard the user terminal 10. An authorization program runs onboard the user terminal and can communicate with policy server 18 which has at least one user account corresponding to the authorization program.
Application service 16 has at least one second user account corresponding to the authorization program that is distinct from the at least one user account.
The authentication device 12 can obtain policies from policy server 18 and can backup information to backup server 17.

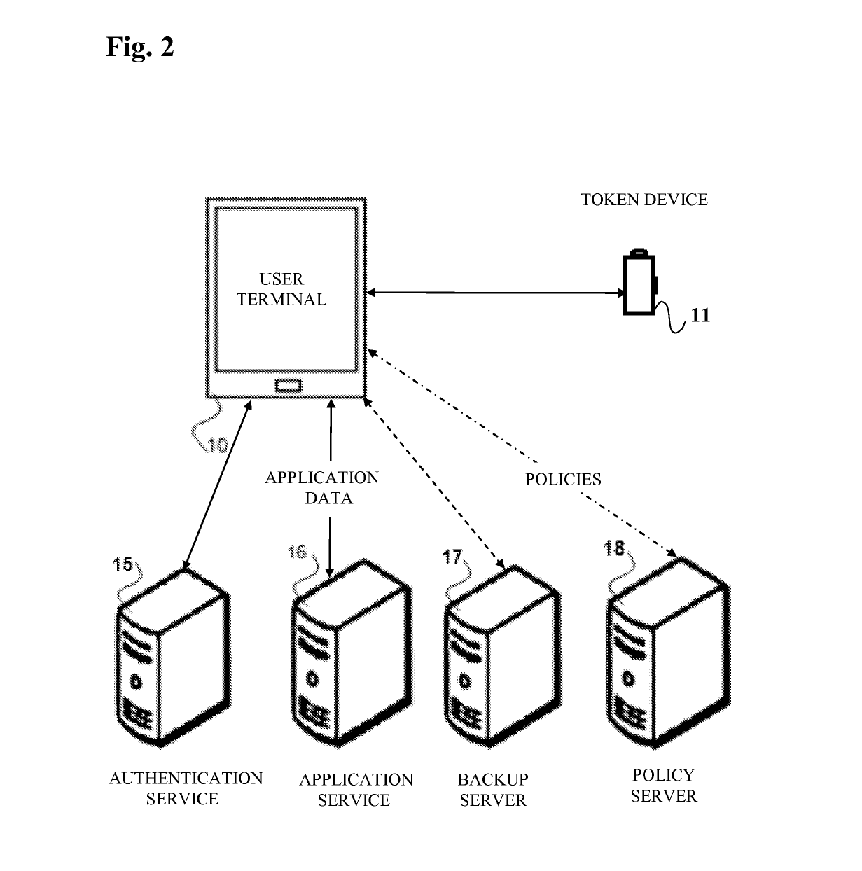

Referring to FIG. 2, the schematic illustrates a system for encryption and decryption using a smart phone. The system for mobile security comprises a user terminal 10, a token device 11, an application service 16, a policy server 18, an authentication server 15 and possibly a backup server 17.

The token device 11 is a Bluetooth fob equipped with short wireless communication means. The authentication service 15 in this case is separate from application service 16. This can be an LDAP or SAML or Kerberos or any authentication service.

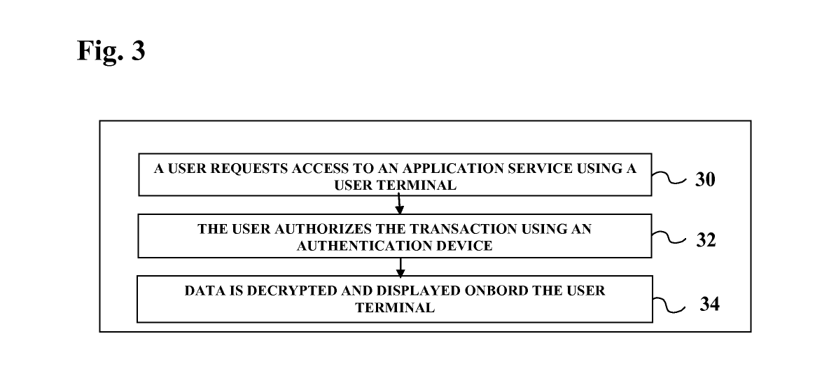

Referring to FIG. 3, the flowchart illustrates encryption and decryption of data. In step 30, a user requests access to an application service using a user terminal. In step 32, the user authorizes the transaction using an authentication device 12. In step 34, data is decrypted and displayed.

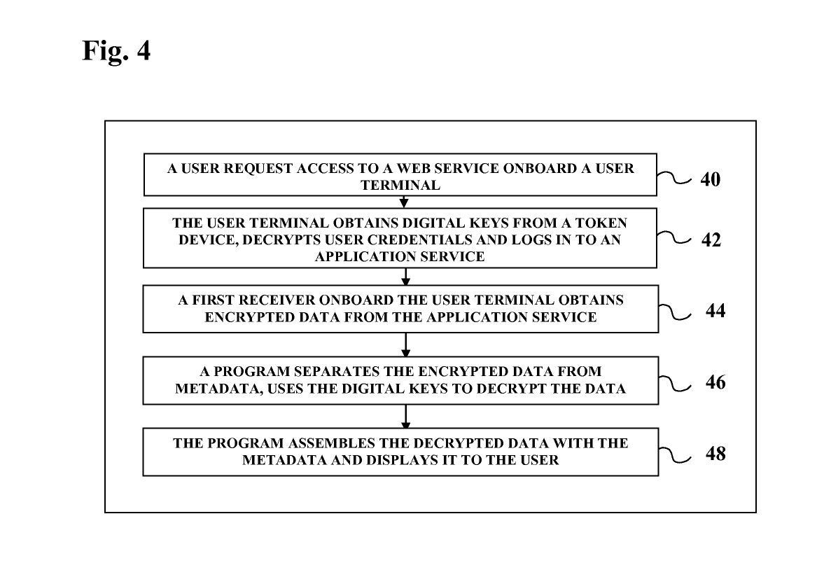

Referring to FIG. 4, the flowchart illustrates encryption and decryption of data for web services. In step 40, a user requests access to a web service or SAAS (software as a service) onboard user terminal 10. In step 42, the user terminal obtains digital keys from a token device, decrypts user credentials and logs in to an application service 15. In step 44, a first receiver such as a web form onboard the user terminal obtains encrypted data from the application service 15. In step 46, a program separates the encrypted data from metadata, and used the digital keys obtained from token device 12 to decrypt the data. In step 48, the program assembles the decrypted data with the metadata and displays it to the user.

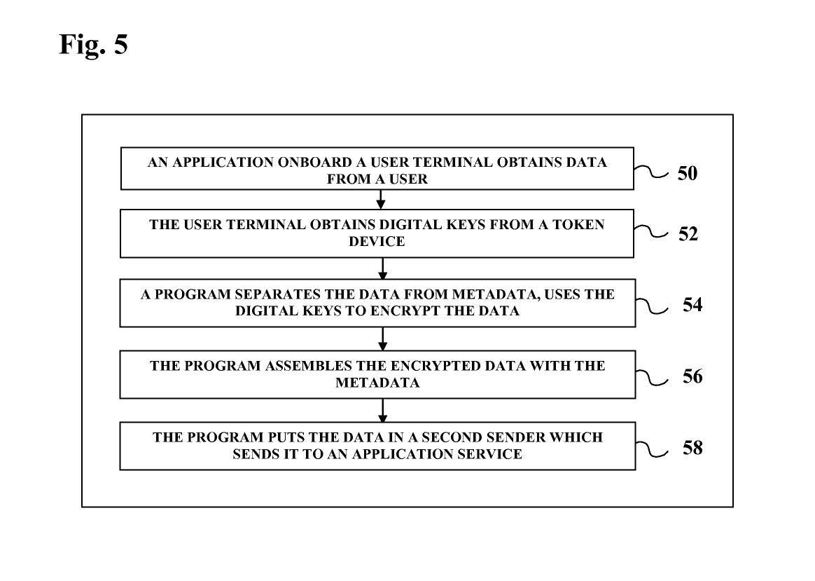

Referring to FIG. 5, the flowchart illustrates an alternative method for encryption and decryption of data for web services. In step 50, an application onboard user terminal 10 obtains data from a user. In step 52, the user terminal 10 obtains digital keys from a token device 12. In step 54, a program separates data from metadata and uses digital keys to decrypt the data. In step 56, the program assembles the encrypted data with the metadata. In step 58, the program puts the data in a second sender or web form which sends it to the application service.

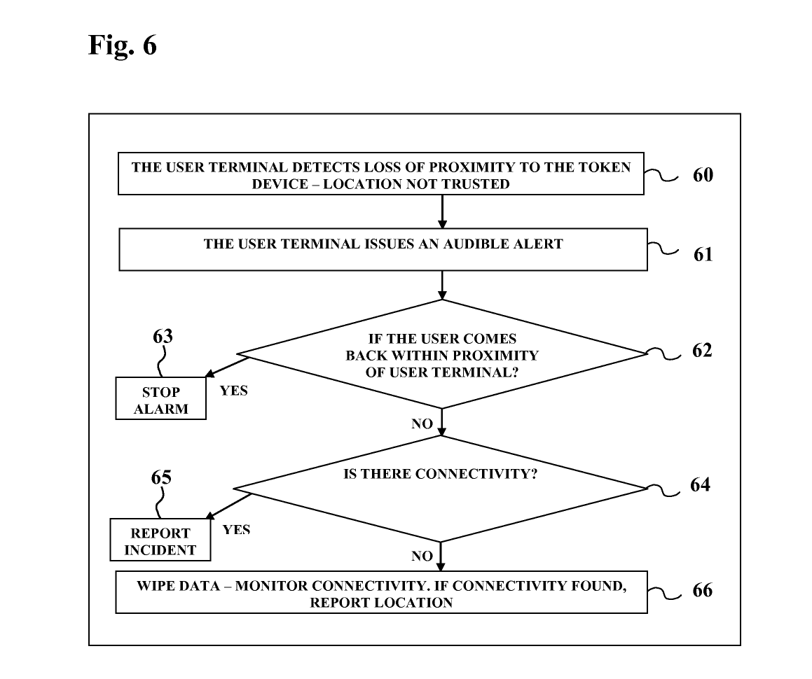

Referring to FIG. 6, the flowchart illustrates proximity security. In step 60, a user terminal 10 detects loss of proximity to the token device, or detects a signal strength below a threshold. The user terminal also detects that the current location is not trusted. In step 61, the user terminal issues an audible alert. In step 62, if the user comes back within proximity, the alarm stops in step 63. If the user does not come back, is there is connectivity in step 64, the user terminal reports the incident in step 65, and reports the current GPS location. In step 66, if there is no connectivity, the user terminal can wipe data or delete encryption keys or encrypted data. It can monitor connectivity. If connectivity is found, it reports the location.

Upon or after an event onboard the user terminal such as a button push, a button slide, a voice instruction or other, the authorization program connects to the token device using short wireless communication. A user can have a number of token devices including a smart phone token and hard tokens, as well as a voice token for voice authentication. Token device is generally more than 10 centimeters away from the user terminal, which is more than the NFC threshold. This enables the user to be authenticated without any contact, and to be able to operate while the token device is within a predefined short wireless proximity distance, such as 1 meter, 10 meters, 20 meters or 30 meters.

Upon a pass code or a voice response is validated without a server either onboard the user terminal or onboard the at least one token device, the user application opens.
The without a server part is important because mobile devices can be off network, and the user must be authenticated with multi-factor in that situation. Today, most MDM solutions enable off-line access with a simple password that can be exploited by keeping the device off-line, and accessing it with a stolen password.
It is also important that the user password be validated with reference code previously stored onboard the token device or in a less desirable fashion, using a second reference code previously stored onboard the user terminal.
Once a user pass code is authenticated, a decryption key is obtained wirelessly from the token device to the user terminal. A login information previously stored onboard the user terminal is decrypted using the decryption key. The login information is used to login automatically to the second user account from the user terminal.
After the user is logged in to application service, a data set corresponding to the second user account is obtained wirelessly from the application service and the data set is decrypted using a digital key obtained through short wireless communication to obtain a decrypted data set onboard the user terminal. The decrypted data is output onboard the user terminal.
Input data set obtained onboard the user terminal is encrypted using at least a digital key obtained through short wireless communication, and the encrypted data set is sent wirelessly to the at least one application service.

After a first user terminal sends encrypted data to an application service, a second user terminal can obtain the encrypted data from the application service. The encrypted data is decrypted on the second user terminal using a decryption key obtained from a second token device. The decryption key can be a symmetric key or a public key corresponding to the sender's private key obtained from the sender's token device.

The current method enables multiple users with multiple user accounts in the application service to login automatically using their token device and to decrypt/encrypt their data using their respective encryption/decryption keys obtained from their respective token device.

The user terminal stores n encrypted login information corresponding to n user with n token devices, and n user accounts in the application service.
Upon a user trying to access information onboard the user terminal, the user terminal—that allows multiple users to login to multiple accounts for the application service—detects a first token device—from among a list of authorized token devices—using short wireless communication. The user enters a pass code that is validated by the token device corresponding to that user, and releases a decryption key corresponding to that user. The decryption key is used to decrypt encrypted login information corresponding to the user. Once decrypted, the user is automatically logged in to the user account for the application service using the user's decrypted login information.
Upon detection of a second token device using short wireless communication, a second pass code corresponding to a second user with a second account can be validated using the second token device, and the second user is automatically logged in to a second user account in the application service.

It is noted that the user pass code authentication or voice authentication is off-line, and uses a reference code previously stored onboard the token device or a reference code previously stored onboard the user terminal for verification.

In a preferred embodiment, the authorization program obtains an authorization method from the policy server that is different from a previous authorization method. If the authorization method requires biometric challenge authentication, the authorization program displays a question and requests a voice response corresponding to the question. If the voice response does not match a previously stored sample, a decryption key is not provided to the user terminal. It is noted that previous voice response samples corresponding to several questions are stored on the token device or user terminal.

If the authorization method requires a second person authorization, the authorization program sends a request for authorization to a second token device. If the request is not authorized onboard the second token device, the decryption key is not provided to the user terminal.

The decryption key or part thereof can be stored onboard the second token device, and only released if the user of the second token device authorizes the request. The authorization application

The authorization program can obtain a first authorization method from the policy server corresponding to at least one trusted location and obtains a second authorization method corresponding to locations outside trusted locations that is different from the first authorization method.

If the current location is determined to be a trusted location, the first authorization method is applied. If the current location is determined to be outside the trusted location, the second authorization method is applied.

The authorization program can obtain a first timeout period from the policy server.

After the first timeout period elapses, decrypted data is cloaked or a screen is locked. If the timeout is not elapsed, the authorization program can encrypt an application data or the authorization program can encrypt a second application data corresponding to a wrapped second application.

The authorization program obtains a first timeout from the policy server corresponding to at least one trusted location and obtains a second timeout corresponding to locations outside the trusted location. If the current location is determined to be a trusted location, the first timeout is applied. If the current location is determined to be outside trusted locations, the second timeout is applied. The first timeout is different from the second timeout.

It is noted that if the token device is not within a predefined short wireless range from the user terminal, displayed data is cloaked or a screen is locked or the authorization program closes. Also, the authorization program can encrypt an application data or delete an application data or delete at least one encryption key. The predefined short wireless range is generally above 20 centimeters such as 5 meters, 10 meters, 20 meters of 30 meters.

In a preferred embodiment, the authorization program is obtained by wrapping a security layer program onto a second application, or by injecting object code corresponding to the security layer program into the object code of the second application.

Generally, the second application cannot communicate with the token device. The security layer program can communicate with the at least one token device. After wrapping, the authorization program can communicate with the token device.

In a preferred embodiment, the encrypted data set is obtained through a web form and the web form is not displayed. The data from the web form is decrypted using the decryption key from the token device and at least one information from the decrypted data set is output onboard the user terminal. Also, input data from the user is encrypted and is provided to the web form before it is sent wirelessly to the application service.

In another method, after the application program is wrapped, a data set corresponding to the application program is encrypted with an encryption key obtained from a token device to obtain an encrypted data set. While the application program can read the data set, the application program cannot read the encrypted data set. Upon or after an event onboard the user terminal, the authorization program connects to a token device using short wireless communication, a decryption key is obtained wirelessly—generally after authentication —, at least one encrypted data set is obtained and is decrypted using the at least one decryption key, the application program reads the decrypted data set, and at least one information from the decrypted data set is displayed onboard the user terminal using the application program.

If the at least one token device is not within a predefined short wireless range from the user terminal, a displayed data is cloaked or a screen is locked, at least one data set corresponding to the application program is encrypted with an encryption key obtained wirelessly to obtain an encrypted data set. The predefined short wireless range is above 30 centimeters.

If the token device is not within a predefined short wireless range from the user terminal, and if the authorization program does not find network connectivity, the authorization program can wipe the application data or the encryption keys. The authorization program can periodically check for network connectivity, and if found, the authorization program sends the current location information to a remote server.

In another embodiment, in case of a multi-user login, N encrypted login information are stored onboard the user terminal. The N encrypted login information correspond to N token devices and N user accounts in the application program. Upon detection of a first token device using short wireless communication, a first user pass code can be validated, a first decryption key is obtained, a first login information stored onboard the user terminal is decrypted, the decrypted first login information is used to login to a first user account in the application program.

Upon detection of a second token device using short wireless communication, a second pass code can be validated, and a second user is automatically logged in to a second user account.

In another embodiment, if a one-time password is obtained from a user, the authorization program generates a second one-time password onboard the user terminal. If the obtained one-time password matches the generated second one-time password, a user is logged in automatically to the application program.

The authorization program can obtain a predetermined safe geo-location from the policy server. The authorization program can determine the current location information using: GPS, Wi-Fi, cell tower, and short wireless transceiver beacon. If the current location is not within the predetermined geo-location defined by GPS coordinates, Wifi, cell tower or Bluetooth beacon, the authorization program performs an action selected from the group consisting of:

log out, revoke authentication, revoke a user token, cancel a transaction, play a long sound file, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

In another embodiment, N encrypted login information are stored onboard the user terminal. The N encrypted login information correspond to N token devices and N user accounts in the application program.

Upon detection of a first token device using short wireless communication whereby the first token device is among a list of pre-authorized token devices, a first pass code is validated using the token device, a first decryption key is obtained from the token device, a first login information stored onboard the user terminal corresponding to the token device is decrypted, the decrypted first login information is used to login to a first user account in the application program.
Upon detection of a second token device using short wireless communication, a second pass code is validated, and a second user is automatically logged in to a second user account.

If a one-time password is obtained by the authorization program, the authorization program generates a second one-time password onboard the user terminal. If an obtained one-time password matches the generated second one-time password, a user is logged in automatically to the application program.

The authorization program obtains at least one predetermined safe geo-location from the policy server. The authorization program determines the current location information using a means selected from the group consisting of: GPS, Wi-Fi, cell tower, and short wireless transceiver. If the current location is not within the predetermined geo-location, the authorization program performs an action selected from the group consisting of: log out, revoke authentication, revoke a user token, cancel a transaction, play a long sound file, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

In another preferred embodiment, upon or after an event onboard the user terminal such as motion detection, button click, spoken command . . . , the authorization program scans devices within a predefined range from the user terminal using short wireless communication. If a known token device is found, login information corresponding to the token device is obtained and is used to authorize to the at least one second user account. At least one information from the at least one second user account is displayed onboard the user terminal.

It is noted that the token device communicates with the policy server using a first communication network. The user terminal communicates with the policy server using a second communication network. The first communication network is different from the second communication network.

In another embodiment a first application runs onboard a first mobile device and obtains a first set of configuration parameters. Upon a user requesting an operation from a second application onboard a second terminal, if the distance between said second terminal and said first mobile device has stayed below a predetermined threshold during a recent period of time: the second application automatically obtains a second set of configuration parameters from said first application using wireless communication. The second set of configuration parameters corresponds to said first set of configuration parameters. Upon authentication of the second set of configuration parameters, the user is authorized to perform the operation. The second application does not request credentials from the user. The recent period of time spans between the last time an application onboard said second terminal obtained configuration parameters from said first mobile device and the current time. If the distance between said second terminal and said first mobile device has exceeded a distance threshold during the recent period of time: the user is requested to enter credentials selected from the group consisting of: pass code, pass phrase, gesture, voice command, finger print. The operation is selected from the group consisting of:

login, authorize payment, authorize access. If the second application is active, and if the distance between said first mobile device and said second terminal exceeds a distance threshold:
the second application determines the current location information using a means selected from the group consisting of: GPS, Wi-Fi, cell tower. If the current location is within a predetermined geo-location, the second application performs an action selected from the group consisting of: no action, log out, revoke authentication, revoke a user token, cancel a transaction, lock a device, play a long sound file. If the current location is outside a predetermined geo-location, the second application performs an action selected from the group consisting of: log out, revoke authentication, revoke a user token, cancel a transaction, play a long sound file, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

Upon a user requesting an operation in a third application:

if the third application determines that a Bluetooth signal between said first mobile device and a third terminal used for running said third application has stayed above a predetermined threshold during a recent period of time:
the user is authorized to perform the operation,
the third application does not request credentials from the user.
If the Bluetooth signal between the first mobile device and said third terminal dropped below a predetermined threshold during the recent period of time:
the third application requests credentials from the user,
the third terminal can be distinct from the second terminal,
the third application can be distinct from the second application.

The mobile device is selected from the group consisting of: a Bluetooth keychain, a Bluetooth bracelet, a Bluetooth badge, a Bluetooth watch. The mobile device obtains the first set of configuration parameters from a remote server through a relay application. The relay application runs in a browser on a third device. The third device connects to said remote server using TCP/IP. The third device connects to said first mobile device using Bluetooth short wireless communication. The first mobile device stores said first set of configuration parameters in a flash memory onboard said first mobile device.

The first application and the second application generate a shared secret key using Diffie-Hellman algorithm. The shared secret key is different from a previously generated shared secret key. The first application uses the shared secret key to encrypt data comprising at least a part of said first set of configuration parameters. The second application uses said shared secret key to decrypt the encrypted data.

Upon the first application receiving a request, the first application generates a one-time password using a method selected from the group consisting of: run a third party one-time password API, call a one-time password function. The first application sends said one-time password to said second application using Bluetooth short wireless communication. A remote server authenticates said one-time password.

The user terminal displaying a challenge question. The displayed challenge question is different from a previously displayed challenge question. The second application sends a challenge question identifier corresponding to the displayed challenge question to said first application. If the first mobile device obtains a user response, the first application authenticates the user response. If the user response is not authenticated, the first application performs an action selected from the group consisting of: close, issue an audible alert, log out, delete application, clear memory, block communication. The user response is selected from the group consisting of: a voice response to a challenge question, a phrase, a fingerprint, an iris scan, a photo capture.

Upon the user requesting access to a second application onboard said second terminal:

If the second terminal cannot connect to said first mobile device using Bluetooth short wireless communication, the second terminal automatically connects to a third mobile device using Bluetooth short wireless communication. The second application obtains the user credentials from said third mobile device. The third mobile device is distinct from the first mobile device.

The second application generates a user report, wherein the user report provides document compliance with U.S. Food and Drug Administration requirements.

A remote server storing at least one first set of configuration parameters. The first set of configuration parameters comprises authentication data selected from the group consisting of:

user credentials, user certificates, user keys, user account information, commands, one time password function, user rules. The first set of configuration parameters comprises a set of authorized terminal identifiers. The first application authenticates the second terminal using said set of authorized terminal identifiers. The set of authorized terminal identifiers is obtained from said remote server.

A remote server stores a set of configuration parameters comprising authentication data selected from the group consisting of: user credentials, user certificates, user keys, user account information, commands, one time password function, user rules. The first set of configuration parameters comprises a set of authorized terminal identifiers. The first application authenticates the second terminal using the set of authorized terminal identifiers. The set of authorized terminal identifiers is obtained from said remote server.

Upon a user requesting an operation in a third application onboard a second terminal.

if the second application determines that a Bluetooth signal between said second terminal and the first mobile device has stayed above a predetermined threshold during a recent period of time: the user is authorized to perform the operation. The third application does not request credentials from the user. If the Bluetooth signal between the second terminal and the first mobile device dropped below a predetermined threshold during the recent period of time: the third application requests credentials from the user. It is noted that the third application is distinct from said second application.

Upon a user requesting an operation in a third application onboard a third terminal:

If the third application determines that a Bluetooth signal between the third terminal and the first mobile device has stayed above a predetermined threshold during a recent period of time:
the user is authorized to perform the operation. The third application does not request credentials from the user. If the Bluetooth signal between said third terminal and the first mobile device dropped below a predetermined threshold during the recent period of time:
the third application requests credentials from the user and the third terminal is distinct from said second terminal.

If the second application is active and if the Bluetooth signal between the first mobile device and the second terminal drops below a predetermined threshold: the second application performs an action selected from the group consisting of: log out, revoke authentication, revoke a user token, cancel a transaction, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

Upon said first application receiving a request, said first application generates a one-time password using a method selected from the group consisting of: Run a third party one-time password API, call a one-time password function. The first application sends said one-time password to said second application using Bluetooth short wireless communication. The remote server authenticates said one-time password.

The second application generates a user report, and the user report provides document compliance with U.S. Food and Drug Administration requirements.

Upon a user requesting an operation in a second application: If the recent period of time exceeded a predetermined threshold, the second application requests credentials from the user.

The second application verifies the Bluetooth signal is above a predetermined threshold only if the user input is not detected for a predetermined period of time. The user input is selected from the group consisting of: typing on a keyboard, touching a screen, moving a mouse.

The first application runs onboard a first mobile device and obtains a first set of configuration parameters from a remote server. The first mobile device connects to the remote server using a cellular data service,

The first set of configuration parameters comprises authentication data selected from the group consisting of: user credentials, user certificates, keys, account information, commands, one time password function. The first set of configuration parameters comprises a set of authorized terminal identifiers. Upon a user requesting an operation from a second application onboard a second terminal, if a Bluetooth signal between said first mobile device and said second terminal has stayed above a predetermined threshold during a recent period of time: the second application requests information from the first application using Bluetooth short wireless communication. The first application authenticates the second terminal using the set of authorized terminal identifiers. The set of authorized terminal identifiers is obtained from the remote server. Upon successful authentication, the second application automatically obtains a second set of configuration parameters from the first application. The second set of configuration parameters corresponds to said first set of configuration parameters. Upon authentication of the second set of configuration parameters, the user is authorized to perform the operation,
The second application does not request credentials from the user. The recent period of time spans between the last time an application onboard said second terminal obtained configuration parameters from the first mobile device and the current time. The credentials are selected from the group consisting of: pass code, pass phrase, gesture, voice command, finger print. The operation is selected from the group consisting of: login, authorize payment, authorize access. If the Bluetooth signal between the first mobile device and said second terminal has dropped below a predetermined threshold during the recent period of time: the second application requests credentials from the user.

When the second application authorizes a user, if the first mobile device is outside a predetermined distance from said second terminal, the second application determines the current location information using a means selected from the group consisting of: GPS, Wi-Fi triangulation, cell tower. If the current location is within a predetermined zone, the second application performs an action selected from the group consisting of: no action, log out, revoke authentication, revoke a user token, cancel a transaction, lock a device, play a long sound file,

If the current location is outside a predetermined zone, the second application performs an action selected from the group consisting of: log out, revoke authentication, revoke a user token, cancel a transaction, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

Upon a user requesting an operation in a third application onboard said second terminal, if the second application determines that a Bluetooth signal between said second terminal and said first mobile device has stayed above a predetermined threshold during a recent period of time: the user is authorized to perform the operation, the third application does not request credentials from the user. If the Bluetooth signal between said second terminal and said first mobile device dropped below a predetermined threshold during the recent period of time:
the third application requests credentials from the user, the third application is distinct from said second application.

The combination of features disclosed in this application allows automatic login, automatic encryption of data when the user is out of proximity using a digital key from a remote token device. The method enables to change security for any legacy application. The method enables to lock access to an application to a device containing encrypted credentials and another one containing an encryption key. The method also enables automatic login.

The details of certain embodiments of the present inventions have been described, which are provided as illustrative examples so as to enable those of ordinary skill in the art to practice the inventions. The summary, figures, abstract and further details provided are not meant to limit the scope of the present inventions, but to be exemplary. Where certain elements of the present inventions can be partially or fully implemented using known components, only those portions of such known components that are necessary for an understanding of the present invention are described, and detailed descriptions of other portions of such known components are omitted so as to avoid obscuring the invention. Further, the present invention encompasses present and future known equivalents to the components referred to herein.

The inventions are capable of other embodiments and of being practiced and carried out in various ways, and as such, those skilled in the art will appreciate that the conception upon which this disclosure is based may readily be utilized as a basis for the designing of other methods and systems for carrying out the several purposes of the present inventions. Therefore, the claims should be regarded as including all equivalent constructions insofar as they do not depart from the spirit and scope of the present invention. The following claims are a part of the detailed description of the invention and should be treated as being included in this specification.

1. A method for proximity encryption and decryption comprising:
using a user terminal, at least one token device, a policy server and at least one application service,
wherein the at least one token device is a Bluetooth fob or a smart phone equipped with short wireless communication means,
and wherein the at least one token device is distinct from the user terminal,
and wherein the at least one token device stores at least one digital key in memory,
and wherein the at least one digital key is used to encrypt data onboard the user terminal,
and wherein an authorization program runs onboard the user terminal,
and wherein the policy server has at least one user account corresponding to the authorization program,
and wherein the at least one application service has at least one second user account,
and wherein the at least one second user account is distinct from the at least one user account;
whereby upon or after an event onboard the user terminal,
the authorization program connects to the at least one token device using short wireless communication,
wherein the at least one token device is more than 10 centimeters away from the user terminal,
after or upon a pass code or a voice response is validated without a server either onboard the user terminal or onboard the at least one token device,
at least one decryption key is obtained wirelessly from the at least one token device,
a login information stored onboard the user terminal can be decrypted using the at least one decryption key,
the login information can be used to login automatically to the at least one second user account from the user terminal,
at least one data set corresponding to the second user account is obtained wirelessly from the at least one application service,
the at least one data set is decrypted using at least a second digital key obtained through short wireless communication to obtain at least one decrypted data set onboard the user terminal,
at least one information from the at least one decrypted data set is output onboard the user terminal,
at least one input data set obtained onboard the user terminal can be encrypted using at least a third digital key obtained through short wireless communication,
and at least one part of the encrypted at least one input data set can be sent wirelessly to the at least one application service.

2. The method of claim 1 comprising:
a second user terminal obtains encrypted data from the at least one application service,
the encrypted data is decrypted using at least one fourth digital key corresponding to the third digital key and is output onboard the second user terminal.

3. The method of claim 1 whereby:
at least two encrypted login information are stored onboard the user terminal, the at least two encrypted login information correspond to at least two token devices and at least two user accounts in the application service,
whereby, upon detection of a first token device using short wireless communication, a first pass code can be validated, a first decryption key is obtained, a first login information stored onboard the user terminal is decrypted, the decrypted first login information is used to login to a first user account in the application service,
whereby, upon detection of a second token device using short wireless communication, a second pass code can be validated, and a second user is automatically logged in to a second user account in the application service.

4. The method of claim 1 whereby:
a pass code is obtained,
wherein the pass code is verified using a first reference code previously stored onboard the at least one token device or using a second reference code previously stored onboard the user terminal.

5. The method of claim 1 whereby:
the authorization program obtains an authorization method from the policy server;
whereby if the authorization method requires biometric challenge authentication, the authorization program displays a question and requests a voice response corresponding to the question;
whereby if the voice response does not match a previously stored sample,
at least one decryption key is not provided to the user terminal.

6. The method of claim 1 whereby:
the authorization program obtains an authorization method from the policy server;
whereby if the authorization method requires a second person authorization, the authorization program sends a request for authorization to a second token device,
whereby if the request is not authorized onboard the second token device,
at least one decryption key is not provided to the user terminal.

7. The method of claim 6 whereby:
the at least one decryption key or part thereof is stored onboard the second token device.

8. The method of claim 1 whereby:
the authorization program obtains at least one first authorization method from the policy server corresponding to at least one trusted location and obtains at least one second authorization method corresponding to locations outside the at least one trusted location;
whereby if the current location is determined to be a trusted location, the at least one first authorization method is applied,
whereby if the current location is determined to be outside the at least one trusted location, the at least one second authorization method is applied,
wherein the at least one first authorization method is different from the at least one second authorization method.

9. The method of claim 1 whereby:
the authorization program obtains a first timeout period from the policy server;
whereby after the first timeout period elapses, at least one decrypted data is cloaked or a screen is locked,
wherein the timeout is not elapsed, the authorization program can encrypt an application data or the authorization program can encrypt a second application data corresponding to a wrapped second application.

10. The method of claim 9 whereby:
the authorization program obtains at least one first timeout from the policy server corresponding to at least one trusted location and obtains at least one second timeout corresponding to locations outside the at least one trusted location;
whereby if the current location is determined to be a trusted location, the at least one first timeout is applied,
whereby if the current location is determined to be outside the at least one trusted location, the at least one second timeout is applied,
wherein the at least one first timeout is different from the at least one second timeout.

11. The method of claim 1 whereby:
if the at least one token device is not within a predefined short wireless range from the user terminal,
a displayed data is cloaked or a screen is locked or the authorization program closes,
wherein the authorization program can encrypt an application data or delete an application data or delete at least one encryption key, and wherein the predefined short wireless range is above 20 centimeters.

12. The method of claim 1 whereby:
the authorization program is obtained by wrapping a security layer program onto a second application, or by injecting object code corresponding to the security layer program into the object code of the second application,
wherein the second application cannot communicate with the at least one token device,
wherein the security layer program enables communication with the at least one token device,
and wherein the authorization program can communicate with the at least one token device.

13. The method of claim 1 whereby:
the at least one data set is obtained through a web form,
wherein the web form is not displayed,
and wherein the data from the web form is decrypted using the at least one decryption key,
and wherein at least one information from the at least one decrypted data set is output onboard the user terminal;
whereby the at least one part of the encrypted at least one input data set is provided to the web form,
wherein data from the web form is sent wirelessly to the at least one application service.

14. A method for proximity encryption and decryption comprising:
using a user terminal, at least one token device, a policy server and an application program,
wherein the at least one token device is a Bluetooth fob or a smart phone equipped with short wireless communication means,
and wherein the at least one token device is distinct from the user terminal,
and wherein the at least one token device stores at least one digital key in memory,
and wherein the at least one digital key is used to encrypt data onboard the user terminal,
and wherein an authorization program runs onboard the user terminal,
and wherein the policy server has at least one user account corresponding to the authorization program,
and wherein the application program has at least one second user account,
and wherein the at least one second user account is distinct from the at least one user account;
whereby at least one data set corresponding to the application program is encrypted with an encryption key obtained from at least one token device to obtain at least one encrypted data set,
wherein the application program can read the at least one data set,
wherein when encrypted, the application program cannot read the at least one encrypted data set;
whereby upon or after an event onboard the user terminal,
the authorization program connects to at least one token device using short wireless communication,
at least one decryption key is obtained wirelessly,
at least one encrypted data set is obtained and is decrypted using the at least one decryption key,
the application program reads the decrypted data set,
and at least one information from the decrypted data set is displayed onboard the user terminal using the application program;
whereby if the at least one token device is not within a predefined short wireless range from the user terminal,
a displayed data is cloaked or a screen is locked,
at least one data set corresponding to the application program can be encrypted with an encryption key obtained wirelessly to obtain an encrypted data set,
and wherein the predefined short wireless range is above 30 centimeters.

15. The method of claim 14 whereby:
if the at least one token device is not within a predefined short wireless range from the user terminal, and if the authorization program does not find network connectivity,
periodically, the authorization program checks for network connectivity, and if found, the authorization program sends current location information to a remote server.

16. The method of claim 14 whereby:
at least two encrypted login information are stored onboard the user terminal, the at least two encrypted login information correspond to at least two token devices and at least two user accounts in the application program,
whereby, upon detection of a first token device using short wireless communication, a first pass code can be validated, a first decryption key is obtained, a first login information stored onboard the user terminal is decrypted, the decrypted first login information is used to login to a first user account in the application program,
whereby, upon detection of a second token device using short wireless communication, a second pass code can be validated, and a second user is automatically logged in to a second user account.

17. The method of claim 14 whereby:
if a one-time password is obtained, the authorization program generates a second one-time password onboard the user terminal,
if obtained one-time password matches the generated second one-time password, a user is logged in automatically to the application program.

18. The method of claim 14 whereby:
the authorization program obtains at least one predetermined safe geo-location from the policy server;
the authorization program determines the current location information using a means selected from the group consisting of: GPS, Wi-Fi, cell tower, and short wireless transceiver;
if the current location is not within the predetermined geo-location,
the authorization program performs an action selected from the group consisting of:
log out, revoke authentication, revoke a user token, cancel a transaction, play a long sound file, lock a device, play a long sound file, issue an audible alert, call a mobile phone and issue a message, encrypt data, delete data, delete said second application, clear memory, send an email message comprising the current location information, send a Short Message Service message comprising the current location information, send a message comprising the current location information to a remote server.

19. A method for proximity encryption and decryption comprising:
using a user terminal, a token device, a policy server, at least one application service and an authorization service,
wherein the at least one token device is a Bluetooth fob or a smart phone equipped with short wireless communication means,
and wherein the at least one token device is distinct from the user terminal,
and wherein the at least one token device stores at least one digital key in memory,
and wherein an authorization program runs onboard the user terminal,
and wherein the at least one digital key is used to encrypt data onboard the user terminal,
and wherein the policy server has at least one user account corresponding to the authorization program,
and wherein the authorization service has at least one second user account,
and wherein the at least one second user account is distinct from the at least one user account,
and wherein the at least one application service has at least one third user account,
and wherein the at least one third user account is distinct from both the at least one user account and the at least one second user account;
whereby upon or after an event onboard the user terminal,
the authorization program scans devices within a predefined range from the user terminal using short wireless communication,
if a known token device is found,
login information corresponding to the token device can be obtained and can be used to authorize to the at least one second user account,
and at least one information from the at least one second user account is displayed onboard the user terminal;
whereby upon or after activation of a button or an icon or a menu from the displayed information onboard the user terminal,
at least one request is sent to the at least one token device or to the policy server,
whereby upon or after authorization of the at least one request by the at least one token device,
authorization information is obtained,
and the authorization information is used to login automatically to the at least one third user account or to authenticate to the at least one third user account or to authorize a transaction corresponding to the at least one third user account onboard the user terminal;
whereby if the at least one token device leaves a predefined short wireless range from the user terminal,
the data from the at least one second user account is automatically cloaked or encrypted, or the at least one second user account is logged off or locked.

20. The method of claim 19 whereby:
the token device communicates with the policy server using a first communication network,
the user terminal communicates with the policy server using a second communication network,
whereby the first communication network is different from the second communication network.
